(19) United States
(12) Patent Application Publication
(10) Pub. No.: US 2002/0133572 A1
(43) Pub. Date: Sep. 19, 2002

(54) Apparatus and method for providing domain name services to mainframe resource mapping

(75) Inventors: Jens Haulund, Trumbull, CT (US); Mark Lutian, Clinton, CT (US)

Correspondence Address: BAKER & HOSTETLER LLP, Washington Square, Suite 1100, 1050 Connecticut Avenue, N.W., Washington, DC, 20036, US

(73) Assignee: Inrange Technologies, Incorporated

(21) Appl. No.: 10/017,380

(22) Filed: Dec. 18, 2001

Related U.S. Application Data
(60) Provisional application No. 60/258,437, filed on Dec. 27, 2000.

(51) Int. Cl. G06F 15/16

(52) U.S. Cl. 709/219; 709/218

(57) ABSTRACT

An apparatus and method for domain name services (DNS) for resources in a mainframe environment. The apparatus includes a locally managed DNS server and a DNS protocol to allow a client to request a mainframe resource. In response to the request, the DNS server returns the selected address of a client. Furthermore, the DNS server chooses an available resource most capable of handling the request based on resource performance characteristics.

### PRIORITY

This application claims priority to the provisional U.S. patent application entitled, DYNAMIC RESOURCE MAPPING IN A TCP/IP ENVIRONMENT, filed Dec. 27, 2000, having a serial No. 60/258,437, the disclosure of which is hereby incorporated by reference.

### FIELD OF THE INVENTION

The present invention relates generally to domain name system mapping. More particularly, the present invention relates to domain name system resource mapping in a mainframe environment.

### BACKGROUND OF THE INVENTION

The Domain Name System (DNS) enables a user or process to ask for a host (computer) by name without having to know the Internet Protocol (IP) address of the host. A common example of DNS is the IP address for www.inrange.com that results in the following sequence of two IP datagrams:

DNS_name_query www.inrange.com is sent to a DNS server as configured in the IP host's gateway statement.

DNS_name_response www.inrange.com is on IP address 192.1.1.1 is the reply from the DNS server.

The current well-defined and understood concepts of DNS are found in RFC 1035 Domain Names-Implementation and Specification, P. Mockapetris, November, 1987, which is further enhanced in several additional RFCs, particularly RFC 2136 Dynamic Updates in the Domain System (DNS UPDATE), P. Vixie, et al.

FIG. 1 illustrates the basic implementation of DNS Protocol logic. Using the DNS protocol described above, a user/DNS requester 10 is able to ask for a host by computer name rather than knowing the IP address of this host computer. As an example, the user/DNS requester 10 requests a host selected from among various IP hosts 14, 16, 18, 20 on an IP network having an IP network name CUSTOMER.COM. The user/DNS requester 10 sends a message to the DNS server 12 with a DNS request for an IP address corresponding to the name of the requested host. The DNS server 12 maintains a table of hostnames as well as one or more IP addresses associated with each hostname. The DNS server 12 receives the request from the user/requester 10, and using the table of host names, resolves the hostname to a corresponding IP address. The DNS server 12 then sends a reply to the user/requester 10 containing the IP address.

In the present example, a hostname lookup of “hostname.customer.com” returns with the IP address 192.1.1.1. A hostname lookup of allhosts.customer.com returns one of four listed IP addresses.

The reason that more than one IP address is associated with a given hostname is to allow for multiple physical processors to deal with incoming requests to the hostname. Thus, the DNS server 12 responds to a request for hostname customer.com with any one of the IP hosts 14,16,18, 20. With the DNS logic described, a simple round-robin assignment of a physical processor takes place.

Currently, there is a need in the mainframe environment for DNS capability. DNS has not been implemented into the mainframe environment due to the inability of mainframes to mesh coherently with other mainframes and open computers. However, “locked” within these mainframes are a number of resources that contain important information. These resources, as well as information contained therein, is not accessible without knowing the actual native standards of the mainframe world. Accordingly, it is desirable to provide a system that provides DNS capability to resources in a mainframe environment.

### SUMMARY OF THE INVENTION

In a first aspect of the invention, a system is provided for DNS mapping to resources in a mainframe environment. The system includes a locally managed DNS server and a DNS protocol to allow a client to request a mainframe resource. In response, the DNS server returns the selected address of the client.

In another aspect of the invention, a client side DNS process is provided for collecting resource performance characteristics. In response to a request for a mainframe resource, the DNS server returns the selected address of the client based upon collected machine performance characteristics of at least one client.

In another aspect of the invention, the system includes mainframe resource polling. This is accomplished by the DNS server either polling the resource and requesting information or having the resource transmit its operability status.

In a further aspect of the system, the DNS server removes the resource for accessing requests. As a result, the resource becomes unavailable through the DNS server. The resource is removed for requests when the resource does not respond to a status or operability inquiry. If, after a period of time, the resource begins to retransmit operability status or responds to inquiries from the DNS server, then the resource is placed back into the DNS server for accessibility.

In an alternate embodiment of the invention, a method for DNS mapping in a mainframe environment is provided. The steps of the method include receiving a DNS request for a resource in a mainframe environment, selecting the resource from among registered mainframe resources and providing an address corresponding to the mainframe resource.

In a further aspect of the invention, the step of collecting performance characteristics on mainframe resources is provided. From these characteristics, an analysis is performed to determine what mainframe resource to select upon a request to the DNS server.

In a further aspect of the alternate embodiment, the step of polling the resource is provided to ensure its operability. In conjunction with the polling, the step of disassociating a resource from the mainframe DNS mapping is provided. This step is taken in response to non-transmittal of the operability status of the resource.

In a further embodiment of the present invention, a system for DNS mapping in a mainframe environment includes means for receiving a DNS request for a resource in a mainframe environment, means for selecting the resource from among registered mainframe resources and means for providing an address corresponding to the mainframe resource.

In another aspect of the alternate embodiment, the system includes means for collecting performance characteristics on mainframe resources. In the preferred embodiment, the means for selecting the resource chooses a suitable resource for access through an analysis of similarly requested mainframe resources.

In another aspect of the preferred embodiment, means for polling the resource to ensure its operability is provided. This element ensures that the resource is operable when a request for the resource is received.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating the concept of DNS protocol.

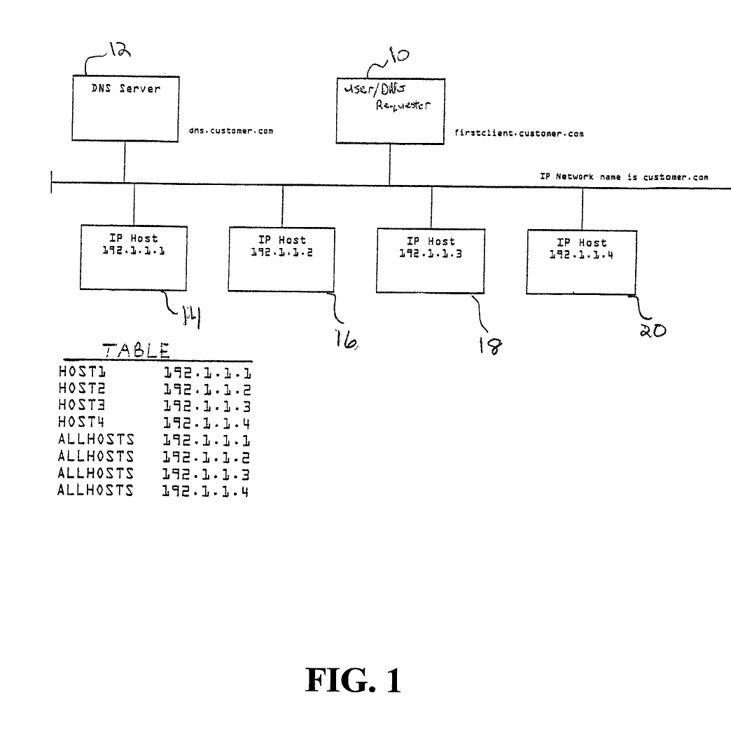

FIG. 2 is a block diagram of a typical mainframe environment.

FIG. 3 is a tree diagram of the DNS system as related to standard TCP/IP protocol and the present invention

FIG. 4 is a block diagram of the present invention in a mainframe environment.

### DETAILED DESCRIPTION OF PREFERRED EMBODIMENTS OF THE INVENTION

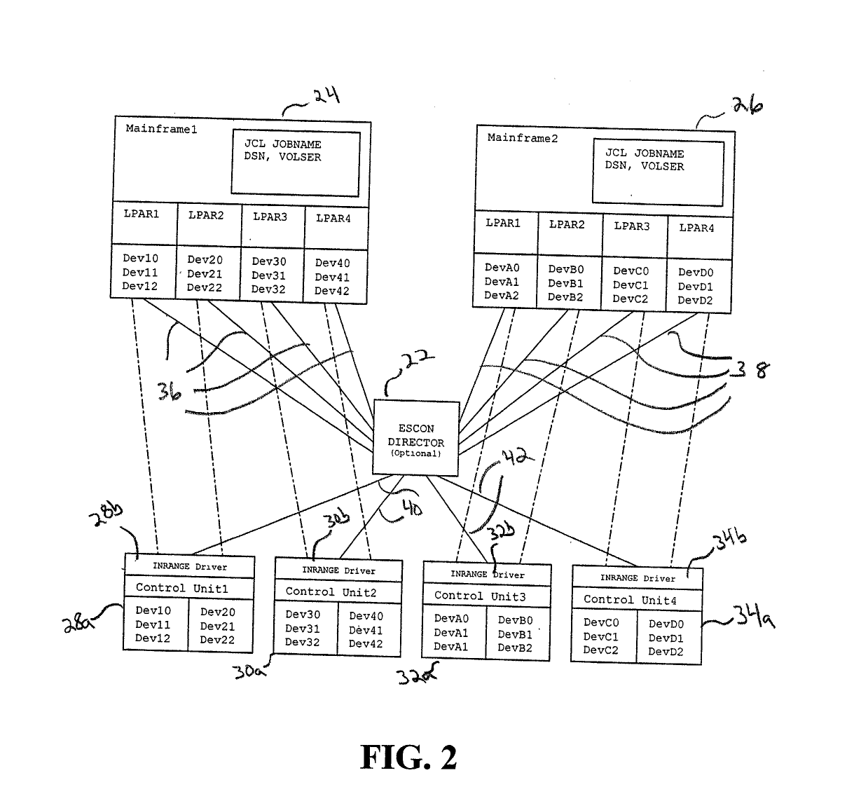

FIG. 2 is a block diagram of a mainframe environment. The environment is connected through an ESCON director 22. The director 22, a dynamically modifiable switch, interconnects the mainframe computers 24,26 with each other and with attached devices 28a, 30a, 32a, 34a using optical fiber technology. Within each mainframe 24, 26 and devices 28a, 30a, 32a, 34a, there are potential applications or information that can be presented through the DNS.

In the preferred embodiment, INRANGE drivers 28b, 30b, 32b, 34b are front loaded at the devices 28a, 30a, 32a, 34a. The location of the driver in the dataflow gives the drivers 28b, 30b, 32b, 34b access to all information being transmitted across the channels 36, 38, 40, 42 of the ESCON director 22. The driver makes decisions based upon label information it receives in the mount request. The driver can be configured to interpret information at given offsets in the data and pass relevant information to the DNS.

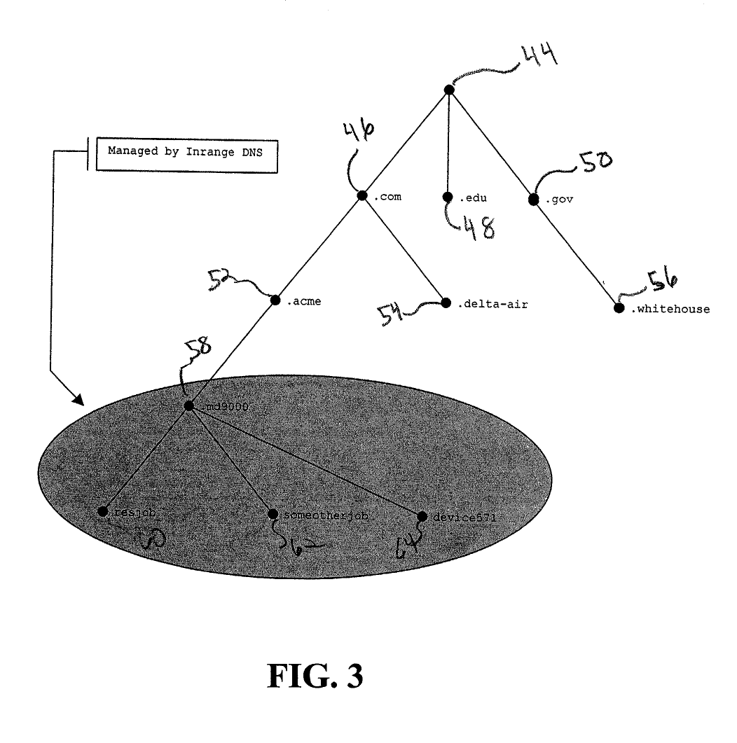

FIG. 3 is a tree diagram of the DNS system as related to standard TCP/IP protocol and the present invention. The top or root level 44 domain is managed by the “administrators” of the Internet. From the root level 44, the Internet is divided into subdomains of which the consuming public is more aware such as .COM 46, .EDU 48 and .GOV 50. These domains are then broken into more specific domain such as ACME.COM 52, DELTA-AIR.COM 54 and WHITEHOUSE.GOV 56. The invention takes advantage of this division of the domains because each level below the root domain becomes more and more locally managed, which provides decentralized administration.

For example, if ACME.COM 52 has their domain under the .COM level, then everything under ACME.COM is managed by the Acme Company. With the present invention, a Message Director System (MD9000) made by Inrange Company of Lumberton, N.J. that is part of Acme's mainframe environment inherits a label in the DNS world such as MD9000.ACME.COM. In the configuration of the Acme's DNS system, the administration of the subdomain MD9000.ACME.COM is delegated from ACME.COM DNS to MD9000.ACME.COM.

A DNS request for the hostname RESJOB.MD9000.ACME. CUSTOMER returns the Internet Protocol (IP) address of the resjob 60 host.

The same procedure is followed with someotherjob 62 and device571 64.

In a mainframe environment, which incorporates the MD9000 product by INRANGE, it is possible that the three hosts resjob 60, someotherjob 62 and device571 64 appear to exist in the MD9000 subdomain 58. In reality, only the names exist. The hosts exist virtually inside one or more MD9000 machines.

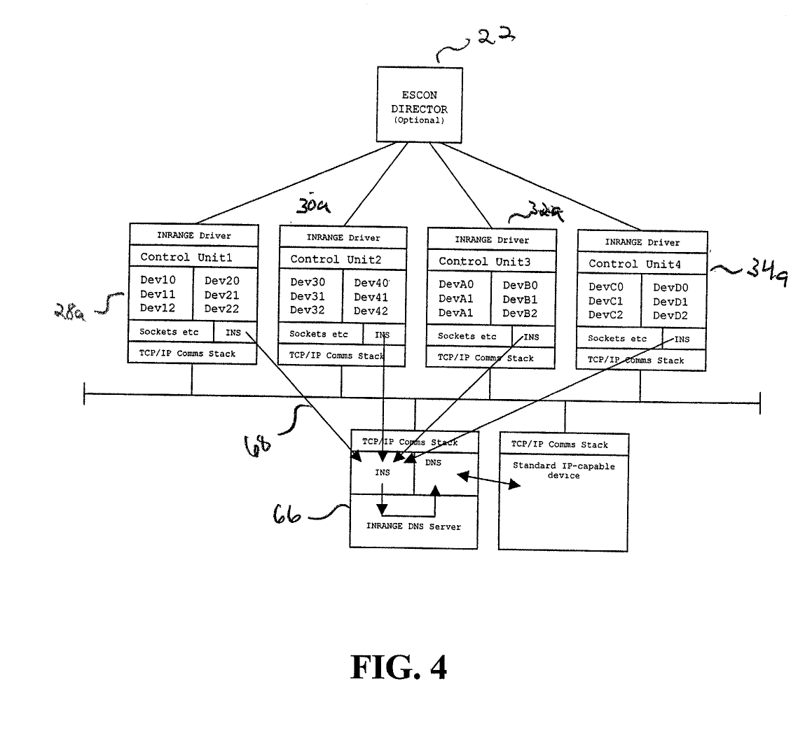

FIG.4 is a block diagram of the present invention as employed in a mainframe environment. The ESCON director 22 is connected to devices 28a, 30a, 32a, 34a in a mainframe environment. In the preferred embodiment, the devices 28a, 30a, 32a, 34a initiate contact with a DNS server 66. This is done to alert the DNS server 66 as to its availability and thus making it available to others that desire access to the information by requesting it through a DNS address instead of the specific numerical address of the computer (e.g., www.frequentflier.com).

The preferred embodiment utilizes a generic uni-directional communications method to accomplish an availability transmission 68 from device 28a to DNS server 66. However, other methods such as bi-directional or unidirectional transmission from the server 66 to the device are within the scope and spirit of this invention.

In an example of the preferred embodiment, a tape is mounted at the address RES1.TEST.PNRDUMP on device address 571, which is on LPAR RESI. The names RES1.TEST.PNRDUMP and LPAR1.571 are transmitted from the MD9000 to the DNS server and then become available for lookup.

If a host on the Internet or Intranet issues the command:

“ping res1.test.pnrdump.md9000.acme.com”

The IP address 192.1.2.3 is returned by the DNS server lookup. Similarly, the command “ftp lpar.571.md9000.acme.com” returns the IP address 192.1.2.3.

In a traditional DNS environment, load balancing is achieved using a round-robin algorithm in the DNS configuration file. The following is an example of this method:

| | |
|---|---|
| goodserver.md9000.acme.com | 192.1.2.1 // First Server |
| goodserver.md9000.acme.com | 192.1.2.1 // Second Server |
| goodserver.md9000.acme.com | 192.1.2.1 // Third Server |
| goodserver.md9000.acme.com | 192.1.2.1 // Fourth Server |
| goodserver.md9000.acme.com | 192.1.2.1 // Fifth Server |

The first request from an IP host to lookup “goodserver” is given the address 192.1.2.1. The requests following the initial request are given 192.1.2.2 and 192.1.2.3 and so on. For this concept to function correctly, the DNS cache maintained by IP hosts in the network should have very short timeouts and the Time-to-Live value returned in the DNS response be set to zero.

In the present invention, the round-robin algorithm can and does exist for commonly named resources. For example, if the job TEST.PNRDUMP is run on different hosts simultaneously, the hosts in the IP environment can request TEST.PNRDUMP.MD9000.ACME.COM. From this request, they are directed to one of many MD9000 processors. This scenario is especially usefully in situations where the workload is distributed to a high number of IP hosts for processing. The following is an illustration of this process.

| | | |
|---|---|---|
| test.pnrdump.md9000.acme.com | 192.1.2.1 | //First MD9000 |
| test.pnrdump.md9000.acme.com | 192.1.2.2 | //Second MD9000 |
| test.pnrdump.md9000.acme.com | 192.1.2.3 | //Third MD9000 |
| test.pnrdump.md9000.acme.com | 192.1.2.4 | //Fourth MD9000 |
| test.pnrdump.md9000.acme.com | 192.1.2.5 | //Fifth MD9000 |
| test.pnrdump.md9000.acme.com | 192.1.2.6 | //Sixth MD9000 |

For specific requests, the request is prefixed with the mainframe name (e.g., RES 1). From this request, the following entries in the table are used:

| | | |
|---|---|---|
| res1.test.pnrdump.md9000.acme.com | 192.1.2.1 | //First MD9000 |
| res2.test.pnrdump.md9000.acme.com | 192.1.2.2 | //Second MD9000 |
| res3.test.pnrdump.md9000.acme.com | 192.1.2.3 | //Third MD9000 |
| res4.test.pnrdump.md9000.acme.com | 192.1.2.4 | //Fourth MD9000 |
| res5.test.pnrdump.md9000.acme.com | 192.1.2.5 | //Fifth MD9000 |
| res6.test.pnrdump.md9000.acme.com | 192.1.2.6 | //Sixth MD9000 |

In a more specific example, the airline carriers' computer system comprises a number of mainframe technologies of which traditional or standard DNS does not support. The information on these systems is essential for many aspects of their business. Contained in these systems are such things as frequent flyer data, special meal data and fare code data.

Access to this type of data in a mainframe environment was difficult especially for other mainframes and open computer systems. With the Inrange MD9000, access to this data has become easier without tremendous code writing in languages for which programmers are hard to find. As a result of the MD9000, this data once deemed accessible to only a few is now available to those who request access.

With the present invention, whether it is in an Intranet or Internet environment, the requester does not need to remember the numerical address of the information. Therefore, if the requester requests access to the frequent flyer information on the internal mainframe system, all they have to do is send out a request for FREQUENTFLYER.ACME.COM as opposed to 192.2.1.

When the request for FREQUENTFLYER.ACME.COM is sent, the DNS server 66 receives the request and proceeds to analyze its table of names for the corresponding IP address. If the resource FREQUENTFLYER. ACME.COM is associated with more than one IP address, the DNS server 66 determines from the collected performance characteristics what resource is most capable of handling it. Furthermore, if the resource FREQUENTFLYER. ACME.COM has become unavailable and fails to poll the DNS server 66, then the FREQUENTFLYER.ACME.COM becomes unavailable for DNS lookup.

The preferred embodiment is dynamic in nature in that the DNS server directs the request to the resource most capable of handling it. As discussed previously, this is based on the collection of performance characteristics by the DNS server 66 with respect to the various resources. The DNS server 66 analyzes performance information such as resource accessibility, resource processing time and number of requests prior to transmitting an IP address. The analysis determines the resource most able to handle the request.

The preferred embodiment also is dynamic in nature in that the DNS server 66 is privy to the operability of a resource. When a request arrives at the DNS server 66, the DNS Server 66 is knowledgeable of the fact as to accessibility of the resource. Unlike standard DNS, the request is not returned with the IP address if the resource is listed as non-operable. Standard DNS does not determine the operability of a resource when returning an IP address

The DNS server 66 is aware of the resource operability by a method known as polling. For example, the DNS server 66 polls the resource over a period of time. The resource transmits a response to the server making it aware of its operability status.

Another method within the scope of this invention, for which operability is determined, is the step of having the resource transmit its operability status to the DNS server 66. In either method used, the DNS server 66 makes the resource available as long as there has been an operability status transmitted within the cycle time. If no transmission has occurred, then the resource is removed from the DNS server 66. If the resource begins to retransmit its operability status, then the DNS server 66 returns it to the server, thus making it available to a request.

The many features and advantages of the invention are apparent from the detailed specification, and thus, it is intended by the appended claims to cover all such features and advantages of the invention, which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A domain name services (DNS) mapping for resources in a mainframe environment comprising:
a locally managed DNS server; and
a DNS protocol to allow a client to request a mainframe resource and the DNS server to return a selected address of a client.

2. The system as in claim 1, further comprising a client side DNS process for collecting resource performance characteristics.

3. The system as in claim 2, wherein the DNS server returns the selected address of the client based upon collected machine performance characteristics of at least one client.

4. The system as in claim 1, further comprising mainframe resource polling.

5. The system as in claim 4, wherein the DNS server polls the resource to ensure it operability.

6. The system as in claim 4, wherein the resource transmits its operability status to the DNS server.

7. The system as in claim 6, wherein the resource does not transmit operability to the DNS server, which in response to the non-transmittal removes the resource from the DNS server.

8. The system as in claim 5, wherein the resource does not respond to the polling by the DNS Server, which in response removes the resource from the DNS server.

9. The system as in claim 8, wherein the DNS server reactivates the resource to the DNS server in response to an affirmation to the polling.

10. The system as in claim 7, wherein the DNS reactivates the resource to the DNS server upon retransmittal of operability status.

11. A method for domain name services (DNS) mapping in a mainframe environment comprising:
receiving DNS request for a resource in a mainframe environment from a user;
selecting the resource from among registered mainframe resources; and
providing an address corresponding to the mainframe resource.

12. The method as in claim 11, further comprising collecting performance characteristics on mainframe resources.

13. The method as in claim 12, wherein in the step of selecting the resource is chosen through an analysis of similarly requested mainframe resources to arrive at a suitable resource for access.

14. The method as in claim 11, further comprising the step of polling the resource to ensure its operability.

15. The method as in claim 14 further comprising disassociating a resource from the DNS mapping in the mainframe environment.

16. A domain name services (DNS) mapping for resources in a mainframe environment comprising:
means for receiving a DNS request for a resource in a mainframe environment from a user;
means for selecting the resource from among registered mainframe resources; and
means for providing an address corresponding to the mainframe resource.

17. The system as in claim 16, further comprising means for collecting performance characteristics on mainframe resources.

18. The system as in claim 16, wherein in the means for selecting the resource chooses a suitable resource for access through an analysis of similarly requested mainframe resources.

19. The system as in claim 16, further comprising means for polling the resource to ensure its operability.

20. The system as in claim 15, wherein the means for selecting is a local DNS server.
